(19) United States
(12) Patent Application Publication
(10) Pub. No.: US 2006/0069822 A1
(43) Pub. Date: Mar. 30, 2006

(54) Optical communication module

(75) Inventors: Shohei Moriwaki, Tokyo (JP); Yoshifumi Azekawa, Tokyo (JP); Osamu Chiba, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/189,837

(22) Filed: Jul. 27, 2005

(30) Foreign Application Priority Data
Sep. 30, 2004 (JP) 2004-287852

(51) Int. Cl. G06F 13/38

(52) U.S. Cl. 710/71

(57) ABSTRACT

An optical communication module includes a physical-layer unit having a first control unit for receiving a write destination address and NVR data from a host via a serial bus, and for carrying out serial/parallel conversion of the received write destination address and NVR data, and storing them in registers of the first control unit, respectively, and a second control unit for copying the stored write destination address and NVR data to corresponding registers of the second control unit, respectively, and for carrying out parallel/serial conversion of the write destination address and NVR data which are copied to the registers of the second control unit, respectively, and sending them to either an EEPROM or a flash memory of a microcomputer, as well as a write command, via another serial bus to write the NVR data into either the EEPROM or the flash memory of the microcomputer.

### BACKGROUND OF THE INVENTION

1. Field of the Invention

The present invention relates to an optical communication module which carries out high-speed transmission by using an optical transmission technology and which is applied to, for example, 10 Gbps Ethernet (registered trademark). More particularly, it relates to a technology for writing NVR data which is used for initial setting into either an EEPROM or a flash memory of a microcomputer in advance.

2. Description of Related Art

In recent years, high-speed high-capacity optical networks have been constructed in order to respond to increase in the information-carrying capacity of the Internet which is caused by the spread of the Internet. As standards for communication equipment for use in high-speed high-capacity optical networks, there has been provided the IEEE802.3ae standard which is a next-generation Ethernet (registered trademark) standard which is aimed to increase the information-carrying capacity of the Internet and which can be applied to connection with trunk networks. As movement toward commercial production of transceivers compliant with the IEEE802.3ae standard, MSAs (Multi Source Agreement: each of which is a formal decision which is made by a group of two or more companies so that they put transceivers into commercial production according to a set of specifications determined by the group) have been pursued. In accordance with an MSA, commonality of the package size of products, pin assignment, specifications, etc. is achieved. As specifications based on the IEEE802.3ae standard which are provided by MSAs, there have been provided XENPAK (the common specifications of optical connectors and optical transceivers which operate according to the protocol of 10 Gbps attachment unit interface), optical transceiver specifications XPAK and X2 which are derived from XENPAK, module downsizing specifications XFP, and so on.

An optical communication module which is compliant with the above-mentioned specifications is constructed as an interface module in which a conversion function of converting a light signal into an electric signal and vice versa, a transmitting circuit, a receiving circuit, a serializer (i.e., a parallel-to-serial conversion circuit), a deserializer (i.e., a serial-to-parallel conversion circuit), a clock recovery circuit, etc. are unified into a package, and is provided with a connector structure for facilitating connection with equipment that handles transmit data and received data. An example of the structure of this type of optical communication module is disclosed by patent reference 1.

In such a related art optical communication module, a PHY (i.e., a physical layer: which is the first one of layers of the OSI layer model having a hierarchical structure, into which communication functions which are defined based on the ISO standards and which computers should have are dividedly assigned, and which defines a network physical connection and a transmission method) unit reads NVR data from a nonvolatile external storage (referred to as an EEPROM from here on), such as an EEPROM disposed in the module, by way of an I2C (International Institute for Communications) bus or the like when a system including the module is started up, and writes the NVR data into an NVR data register thereof so as to place itself in an initial state. The NVR data are data for initial setting (or initialization) which are stored in an NVR (non-volatile storage register, in this case, the above-mentioned EEPROM) which is defined by the XENPAK specifications. The I2C bus is a serial bus which is proposed by Phillips Corp., and connects between two or more pieces of equipment using lines via which a serial clock and two signals for serial data are respectively transmitted.

The related art optical communication module is a unit into which ICs, such as an ASIC which constitutes the PHY unit, the above-mentioned EEPROM, and a microcomputer which performs various control operations, are modularized. In order to simplify the structure of the related art optical communication module, a flash memory of the microcomputer can be used for storing the NVR data, instead of the EEPROM. In this case, the I2C bus is also used to transfer the NVR data to the PHY unit.

[Patent reference 1] JP,2004-153403,A

[Nonpatent reference 1] “Use The MDIO BUS To Interrogate Complex Devices” Electronic Design, [online], [retrieved on Sep. 21, 2004], Internet URL <http://www.elecdesign.com/Articles/Index.cfm?ArticleID=349 7&pg=1>

While the PHY unit, EEPROM, and microcomputer are mounted, as independent parts, in the above-mentioned optical communication module, the NVR data needs to be written into the EEPROM or a flash memory of the microcomputer in advance. Therefore, a serial bus, such as an I2C bus, is disposed between an external host which provides the NVR data to the module and the EEPROM or the microcomputer. Since this bus is positioned outside the optical communication module, a number of pins defined by the specifications with which the module complies are consumed. As a result, restrictions are imposed on the design of an additional function which newly requires a number of pins.

### SUMMARY OF THE INVENTION

The present invention is made in order to solve the above-mentioned problem, and it is therefore an object of the present invention to provide an optical communication module in which an excess number of pins can be effectively used without having to provide any serial bus intended for writing of NVR data from outside the module into either an EEPROM or a microcomputer.

In accordance with the present invention, there is provided an optical communication module that accepts first NVR data for initial setting from an external host in advance, and writes and stores the first NVR data into either an EEPROM or a flash memory of a microcomputer, and that transfers and sets the first NVR data to an NVR data register of a physical-layer unit having a communications function via a first serial bus when a system including the module is started up, the physical-layer unit carrying out communications based on the first NVR data set to the NVR data register thereof, the physical-layer unit including: a first control unit for receiving a write destination address and second NVR data associated with the write destination address from the host via a second serial bus which is disposed for transmission of various management data between the host and the physical-layer unit, and for carrying out serial/parallel conversion of the received write destination address and second NVR data, and storing therein registers thereof, respectively; and a second control unit for copying the stored write destination address and second NVR data to corresponding registers thereof, respectively, and for carrying out parallel/serial conversion of the write destination address and second NVR data which are copied to the corresponding registers, respectively, and sending them to either the EEPROM or the flash memory of the microcomputer, as well as a write command, via the first serial bus so as to write the second NVR data into either the EEPROM or the flash memory of the microcomputer.

The module in accordance with the present invention can perform writing of NVR data into either the EEPROM or fresh memory of the microcomputer, and updating and erasing of the NVR data by using the second serial bus which is a dedicated serial bus used for transmission of other management data, thereby avoiding the necessity for additionally installing a serial bus for writing NVR data into the optical communication module in the exterior of the optical communication module, and hence reducing the limited number of pins included in the optical communication module. Therefore, the present invention offers an advantage of being able to effectively use an excess number of pins for other additional functions.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram schematically showing the structure of an optical communication module in accordance with embodiment 1 of the present invention; and

FIG. 2 is a block diagram showing the circuit configuration of an MDIO bus and a serial bus in accordance with embodiment 1 of the present invention.

### DETAILED DESCRIPTION OF THE PREFERRED EMBODIMENTS

### Embodiment 1

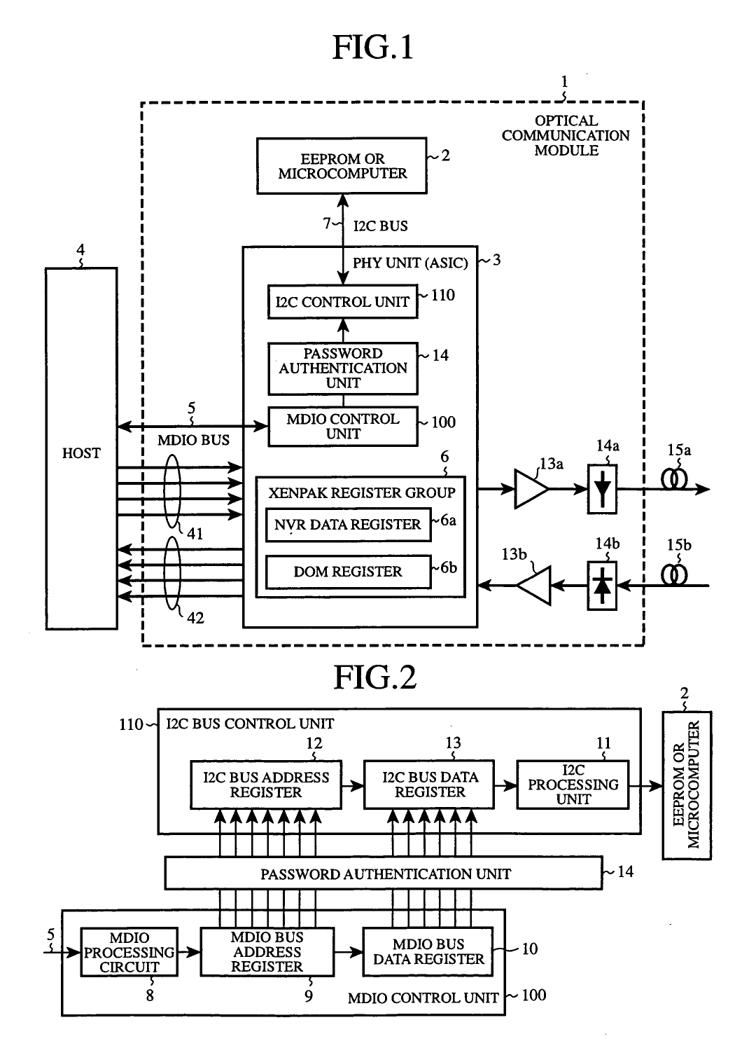

FIG. 1 is a block diagram schematically showing the structure of an optical communication module in accordance with embodiment 1 of the present invention. Hereafter, part of the optical communication module associated with the present invention will be explained mainly.

The optical communication module 1 is so constructed as to be compliant with specifications, such as above-mentioned XENPAK, XPAK, X2, or XFP. The optical communication module 1 is provided with a 10 Gbps-capable PHY unit (i.e., a physical-layer unit) 3 which consists of an ASIC and has a communication function, an EEPROM or a microcomputer 2 having a flash memory, and an operation function and peripheral functions, a laser light emitting element 14a, a light receiving element 14b, a driver 13a, an input amplifier 13b, etc. A main function of the microcomputer, which is not a subject of the present invention, is to keep the output of the laser light emitting element 14a constant, and to monitor the status of the photo detector 14b, such as its life and connection. To this end, the microcomputer monitors a bias applied to the laser light emitting element 14a, which depends upon a change in the temperature of the laser light emitting element 14a, by using the driver 13a, so as to generate a signal indicating the bias, converts the signal into a digital signal, performs data processing on the digital signal so as to acquire an analog control signal, and then controls the driver 13a so as to keep the output of the laser light emitting element 14a constant. The microcomputer also monitors a current value of the input amplifier 13b and a bias applied to the photo detector 14b, and outputs alarm data to a host 4 via an MDIO (Management DATA Input/Output) bus (i.e., a second serial bus) 5 according to a change in the bias.

The PHY unit 3 is provided with an MDIO control unit (i.e., a first control unit) 100, an I2C control unit (i.e., a second control unit) 110, a password authentication unit 14, an NVR data register 6a, a DOM (Digital Optical Monitoring) register 6b, etc. The NVR data register 6a is the one into which NVR data (i.e., first NVR data) transmitted from the above-mentioned EEPPROM or microcomputer 2 is written so that the PHY unit 3 is initialized. An I2C bus (i.e., a first serial bus) 7 is a serial bus via which the NVR data stored in the EEPROM or microcomputer 2 is transferred to the PHY unit 3. The password authentication unit 14, MDIO control unit 100, and I2C control unit 110 will be explained later with reference to FIG. 2.

On the other hand, the host 4 is an exchanger which uses a network processor, and transmits and receives parallel data to and from the PHY unit 3 by way of parallel buses 41 and 42. The host 4 transmits the NVR data which are to be written into the EEPPROM or microcomputer 2 in advance to the PHY unit 3. The MDIO bus 5 is a dedicated serial interface via which the host 4 transmits and receives management data used for performing various managements to and from the PHY unit 3. In FIG. 1, the usage of the MDIO bus is shown while attention is focused on portions specific to the present invention. Optical fibers 15a and 15b are the ones via which the optical communication module 1 receives and transmits a light signal from and to the optical network.

The MDIO bus is a dedicated bus compliant with the IEEE RFC802.3, and two pins: an MDIO pin and an MDC (Management Data Clock) pin are defined, as an interface, for the MDIO bus. The structure of MDIO frames which are used for communications is defined (refer to, for example, nonpatent reference 1).

The normal operation of the optical communication module will be explained. In the optical communication module which is placed in an initial state, when NVR data are transmitted and set from the EEPROM or microcomputer (i.e., a flash memory) 2 in which the NVR data are stored beforehand, via the I2C bus 7, to the NVR data register 6a, the PHY unit 3 can start communications processing based on the NVR data. When parallel data from the host 4 is inputted via the parallel bus 41, the PHY unit 3 converts the parallel data into serial data, performs predetermined modulation on the serial data, and outputs the modulated serial data to the driver 13a. The modulated signal output via the driver 13a is then furnished to the laser light emitting element 14a, and is converted into a light signal. The converted light signal is transmitted onto the optical network via the optical fiber 15a. On the other hand, when a light signal is inputted to the module via the optical fiber 15b, the photo detector 14b accepts this light signal and converts it into an electric signal. The PHY unit 3 demodulates the electric signal into which the received light signal is converted so as to obtain serial data, converts the serial data into parallel data, and transmits it to the host 4 via the parallel bus 42.

FIG. 2 is a block diagram showing configuration of circuits for use with the MDIO bus and serial bus. An MDIO processing circuit 8 is a unit for carrying out serial/parallel conversion of data input thereto via the MDIO bus 5. An MDIO bus address register 9 is a unit for temporarily holding a write destination address specifying a destination where the data input via the MDIO bus 5 is to be written. An MDIO bus data register 10 is a unit for temporarily holding the NVR data associated with the above-mentioned write destination address. An I2C processing circuit 11 is a unit for performing serial/parallel conversion on data which is to be transmitted to the. EEPROM or microcomputer via the I2C bus 7. An I2C bus address register 12 is a unit for temporarily holding a write destination address specifying a destination where the data to be transmitted via the I2C bus 7 is to be written into the EEPROM or microcomputer. An I2C bus data register 13 is a unit for temporarily holding the NVR data associated with the write destination address held by the I2C bus address register 12. The password authentication unit 14 is a unit for verifying whether or not an authentication password input for access to NVR data is valid.

Next, a characterized operation in accordance with this embodiment 1 will be explained with reference to FIGS. 1 and 2. First, an authentication password for access to NVR data is sent from the host 4 to the optical communication module 1 via the MDIO bus 5. The MDIO processing circuit 8 carries out serial/parallel conversion of the authentication password and delivers it to the password authentication unit 14 so as to cause the password authentication unit 14 to verify whether or not the input authentication password is valid. When verifying that the password is valid, the password authentication part 14 frees both a data path which connects between the MDIO bus address register 9 and the I2C bus address register 12 and a data path which connects between the MDIO bus data register 10 and the I2C bus data register 13. The MDIO processing circuit 8 of the PHY unit 3 then carries out serial/parallel conversion of a write destination address and NVR data associated with this write destination address which are sent thereto, via the MDIO bus 5, from the host 4, and stores the write destination address and NVR data in the MDIO bus address register 9 and MDIO bus data register 10, respectively. The stored write destination address and NVR data are then transferred and copied from the MDIO bus address register 9 and MDIO bus data register 10, by way of the password authentication unit 14, to the I2C bus address register 12 and I2C bus data register 13, respectively. After carrying out parallel/serial conversion of the write destination address and NVR data which are copied into the I2C bus address register 12 and I2C bus data register 13, respectively, the I2C processing circuit 11 sends them to the EEPROM or microcomputer 2, as well as a write command, so that the NVR data is written into a location of the EEPROM or flash memory of the microcomputer which is specified by the write destination address.

As mentioned above, the module in accordance with this embodiment 1 can perform writing of NVR data into either the EEPROM or fresh memory of the microcomputer, and updating and erasing of the NVR data by using the MDIO bus 5 which is a dedicated serial bus used for transmission of other management data, thereby avoiding the necessity for additionally installing a serial bus for writing NVR data into the optical communication module 1 in the exterior of the optical communication module 1. That is, since a number of pins required for a serial bus for writing NVR data into the optical communication module 1 can be eliminated, an excess number of pins can be effectively used for other additional functions.

Since the module in accordance with this embodiment 1 has a mechanism for locking copying of NVR data from the MDIO bus data register to the I2C bus data register by using a password security method of verifying whether or not an input password is valid, the module can prevent unauthorized writing and reading of NVR data into and from the EEPROM or microcomputer of the module.

Many widely different embodiments of the present invention may be constructed without departing from the spirit and scope of the present invention. It should be understood that the present invention is not limited to the specific embodiments described in the specification, except as defined in the appended claims.

1. An optical communication module that accepts first NVR data for initial setting from an external host and writes and stores the first NVR data into either an EEPROM or a flash memory of a microcomputer, and that transfers and sets the first NVR data to an NVR data register of a physical-layer unit having a communications function via a first serial bus, when a system including said module is started up, said physical-layer unit carrying out communications based on the first NVR data set to the NVR data register of said physical-layer unit, said physical-layer unit comprising:
a first control unit for receiving a write destination address and second NVR data associated with the write destination address from the host via a second serial bus for transmission of various management data between the host and said physical-layer unit, and for carrying out serial/parallel conversion of the write destination address received and the second NVR data, and storing the write destination address received and the second NVR data in registers of said first control unit, respectively; and
a second control unit for copying the store write destination address and the second NVR data stored to corresponding registers of said second control unit, respectively, and for carrying out parallel/serial conversion of the write destination address and the second NVR data which are copied to the corresponding registers, respectively, and sending the write destination address and the second NVR data to either the EEPROM or the flash memory of the microcomputer, as well as a write command, via the first serial bus to write the second NVR data into either the EEPROM or the flash memory of the microcomputer.

2. The optical communication module according to claim 1, wherein said physical-layer unit includes a password authentication unit for verifying whether an input password for access to the second NVR data is valid when the writing of the second NVR data via the first serial bus is carried out, and for, when verifying that the input password is valid, freeing data paths which connect said registers of said first control unit to said registers of said second control unit, respectively, and the password is sent from the host to said physical-layer unit via the second serial bus before the write destination address and the second NVR data associated with the write destination address are copied to said registers of said second control unit, and said first control unit carries out serial/parallel conversion of the input password and then send the password input to said password authentication unit.
